(19) United States
(12) Patent Application Publication
(10) Pub. No.: US 2014/0085664 A1
(43) Pub. Date: Mar. 27, 2014

(54) Methods and Systems for Sharing Photographs with a Third Party Printer

(71) Applicant: ADOBE SYSTEMS INCORPORATED, San Jose, CA (US)

(72) Inventors: Tim Riot Riherd, San Francisco, CA (US); David Alonzo, San Jose, CA (US)

(73) Assignee: Adobe Systems Incorporated, San Jose, CA (US)

(21) Appl. No.: 13/628,337

(22) Filed: Sep. 27, 2012

(51) Int. Cl. G06K 15/02

(52) U.S. Cl. 358/1.15

(57) ABSTRACT

Systems and methods are discussed to sharing photographs with a third party printer. The current geographic location of a mobile device may be determined. For example, GPS functionality may be used to determine the current location of the mobile device associated with the user. The coordinates for a printer region can be determined. The current geographic location of the mobile device may be within the print region. One or more third party printers may be identified as being within the print region. One or more third party printers that are within the print region are selected. At least one photograph electronically stored on the mobile device is provided to the selected one or more third party printers. The selected one or more third party printers can print the at least one photograph.

### FIELD

This disclosure relates generally to sharing photographs. In particular, the present invention relates to sharing photographs with a third party printer.

### BACKGROUND

Traditional methods of providing photographs to third party printers generally requires a person interested in obtaining copies of the photographs to physically visit a store of the third party printer with some type of device storing the photographs. For example, a person may take to the third party printer a USB flash drive that contains copies of the photographs of which the person wants printed copies. The person would provide a cashier or print specialist with the USB flash drive and explain to the cashier or print specialist which photographs should be printed. More modern methods of providing photographs to third party printers allows a person to upload photographs to a website associated with a third party printer. The third party printer will receive the photographs and print the photographs so they can be retrieved from the third party printer's store.

However, there is no adequate mechanism for quickly and efficiently providing photographs to a third party printer that is within the same or similar geographical location as the person requesting printed copies of photographs. To that end, existing methods and applications that allow a user to send photographs to a third party printer are limited with respect to their intuitiveness and/or capabilities.

### SUMMARY

Embodiments according to the present disclosure provide methods and systems for sharing photographs with a third party printer. For example, one disclosed embodiment is a method comprising determining a current geographic location of a mobile device; determining coordinates for a print region, the current geographic location of the mobile device being within the print region; identifying one or more third party printers that are within the print region; receiving a selection of the one or more third party printers that are within the print region; and providing at least one photograph electronically stored on the mobile device to the selected one or more third party printers, wherein the selected one or more third party printers are configured to print the at least one photograph. In another embodiment, a computer-readable medium comprises program code for causing one or more processors to execute such a method.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings, where:

FIG. 1 is a block diagram depicting an exemplary system for implementing sharing photographs with a third party printer;

FIG. 2 is a block diagram depicting an exemplary system for implementing sharing photographs with a third party printer;

FIG. 3 is an illustration depicting an exemplary user interface for a photo sharing application; and

FIG. 4 is a flow chart illustrating an exemplary method of sharing photographs with a third party printer.

### DETAILED DESCRIPTION

Systems and methods are disclosed to facilitate sharing photographs with a third party printer. The methods and systems disclosed herein may be used in a variety of contexts and provide various advantages and features. To illustrate certain features and advantages the following discussion describes an embodiment in which electronically stored photographs are provided to a third party printer that is within a print region of a mobile device. However, it will be understood by those of skill in this art that the methods and techniques may be used in other circumstances and may be modified and adjusted as appropriate to address the particular requirements presented by those circumstances.

In one exemplary embodiment, systems and methods for sharing photographs with a third party printer provides a quick and efficient way to provide electronically stored photographs to one or more third party printers that are within a certain region of a mobile device. For example, photographs electronically stored on a mobile device and/or captured using the mobile device may be provided to one or more third party printer selected printers by the mobile device user that are within the print region. The third party printer can receive the photographs from the mobile device and print the photographs. Either the user of the mobile device or some other designated individual can retrieve the printed photographs from the third party printer.

In particular, various embodiments of systems and methods for sharing photographs with a third party printer provide an environment where at least one photograph that has been captured and/or electronically stored on a mobile device can quickly be provided to one or more selected third party printers that are within a print region. The third party printer can print the photographs and have them ready for the user of the mobile device and/or another designated individual to obtain. The term “third party printer” is used generally herein to refer to a retailer that offers the ability to print photographs. For example, a third party printer comprises a retailer or other service provider that maintains a physical store and provides the ability to print photographs in or outside of the physical store, a printer on demand kiosk present in any location, a printer located in a home, and the like. The photograph or photographs provided to the third party printer are captured and/or stored on a mobile phone or other device (collectively referred to herein as a “mobile device” or “mobile terminal”). The term “print region” is used generally herein to refer to a region or geographic area around the mobile device associated with a user. The print region may be defined by the user of the mobile device. In some embodiments, the print region is defined by someone other than the user of the mobile device.

In some embodiments, systems and methods for sharing photographs with a third party printer may use at least mobile device technology, global positioning system technology, Internet-based technology, cloud computing technology, network server technology, and a software executable applications. In some embodiments, the user may interact with an application (referred to herein as a “photo sharing application”) to provide at least one photograph captured using and/or electronically stored on the mobile device to one or more third party printers. The user may also use the photo sharing application to manipulate a photograph before sending it to the third party printer. For example, the user may adjust the color of a photograph, decrease or increase the size of the photograph, blow up the size of the photograph, and the like. The user may manipulate the photograph using software, such as super resolution software, that is part of the photo sharing application. The user may also use the photo sharing application to identify one or more third party printers that are within the print region. The user may use the photo sharing application to select one or more third party printers within the print region. The user may also use the photo sharing application to designate to the third party printer one or more individuals that may receive the printed photograph. In some embodiments, the user may use the photo sharing application to capture photographs.

The photo sharing application may incorporate GPS-functionality, location-based functionality, photo capturing functionality, interactive map functionality, photo manipulation functionality, photo album creating functionality, typing functionality, third party printer designation functionality, and many other similar features. The photo sharing application runs on the user's mobile device. However, it is possible that the photo sharing application may be run on another device, such as the user's desktop or laptop computer, a network server, and the like. The photo sharing application may be provided via a cloud, for example, as part of a cloud-based photo archive system.

In some embodiments, the user may define the print region. The print region may be defined by the user interacting with the photo sharing application. For example, the user may define a print region by interacting with a graphical user interface of the photo sharing application. The user may enter a distance (i.e. square footage or mileage) that represents a geographical area around the user's current location. In some embodiments, the user may define a print region by entering a zip code within a graphical user interface of the photo sharing application. In this embodiment, the user may also enter a distance that represents a geographical area around a designated point that represents the zip code. In this embodiment, the mobile device associated with the user may or may not be within the print region.

In some embodiment, another party other than the user may define the print region. For example, the photo sharing application may have a default print region. In this example, the default print region may include one or more third party printers within 5 miles of the mobile device associated with the user. These and other methods for defining a print region will occur to those of skill in the art.

In some embodiments, the system may determine the location of the mobile device associated with the user in a variety of different ways, such as by GPS technology, Internet-based technology, etc. The location of the mobile device associated with the user may be determined by monitoring the coordinates of the mobile device. The specific coordinates may be used to determine an address where the user is currently located. The mobile device of the user may be within the print region.

In some embodiments, the system may detect and determine whether one or more third party printers are within the print region. The system may use a variety of different ways, such as by GPS technology, Internet-based technology, etc., to determine whether one or more third party printers are within the print region. The system may search for a third party printer within a database to obtain the coordinates of the third party printer. The system may search the Internet for an address, location and/or coordinates of a third party printer. In some embodiments, the system may use the print region and identify one or more third party printers that are within the print region. The system may compare the coordinates of the one or more third party printers to the print region. The one or more third party printers that are within the print region may be identified on a graphical user interface of the mobile device of the user. In some embodiments, the system may detect and determine third party printers that are not within the print region. The third party printers that are not within the print region may be identified on a graphical user interface of the mobile device of the user.

In some embodiments, the user may select one or more third party printers. The user may use the mobile device to select the one or more third party printers. Generally, the user may select one or more third party printers that are within the print region. In some embodiments, the user may select one or more third party printers that are not within the print region. The user may select the one or more third party printers by using the graphical user interface of the mobile device. For example, the graphical user interface of the photo sharing application may provide the user with a list of third party printers that are within the print region and the user may select one or more third party printers. In some embodiments, the user may select the one or more third party printers by entering or inputting some other identifier associated with the third party printer. For example, the user may input an address associated with the third party printer. In another example, the user may input the name of the third party printer. In some embodiments, the system may automatically select the one or more third party printers without user interaction.

In some embodiments, the user may provide at least one photograph to one or more third party printers that are selected. The at least one photograph provided by the user to the selected one or more third party partners may be electronically stored on the mobile device. The at least one photograph provided by the user to the selected one or more third party partners may be stored on a server of a cloud computing network. The user may select the one or more photographs to send to the third party printer. The user may select the at least one photograph that is designated to be provided to the selected one or more third party partners.

The user may also provide an indication to one or more third party printers to print the at least one photograph. For example, the user may provide a message to a third party printer to print the photographs provided by the user. In some embodiments, the user may indicate certain features that should be associated with the at least one photograph when it is printed. For example, the user may indicate the size, color and other characteristics that should be associated with at one photograph when it is printed. In another example, the user may indicate the type of paper in which the at least photograph should be printed. The user may also provide a message, such as a text message, that should be included on the printed at least one photograph. In an example, the user may indicate that at least one photograph should be printed on a greeting card. In this example, the user may also provide a text message that should be included on the greeting card that includes at least one photograph printed thereon. In some embodiments, the user may also provide one or more individuals that are designated to obtain printed copies of at least one photograph printed by one or more third party printers.

The one or more third party printers receive the at least one photograph from the user. The one or more third party printers may analyze any message received that may be associated with the at least one photograph. The third party printer may also identify one or more individuals that are designated to receive printed copies of the at least one photograph. The third party printer may print the at least one photograph. The third party printer may print the at least one photograph in accordance with the user's indications. The third party printer may print the at least one photograph on a letter, press card, poster, in a photo hook, arid the like. The third party printer may provide at least one photograph to one or more individuals designated by the user or some other individual.

In some embodiments, the user uses a mobile device to capture the at least one photograph. The mobile device generally includes functionality that permits the mobile device to capture photographs. For example, the user may be attending a baseball game at Fenway Park and may use a cell phone to take pictures of the baseball field and the baseball players. The captured photograph may be electronically stored on the mobile device. In some embodiments, the captured photographs may be electronically stored on a server on a cloud computing network. In some embodiments, the captured photographs may be electronically stored on the mobile device and stored on a cloud computing network.

These illustrative examples are given to introduce the reader to the general subject matter discussed here and are not intended to limit the scope of the disclosed concepts. The following sections describe various additional embodiments and examples with reference to the drawings in which like numerals indicate like elements.

### Illustrative Devices and Systems

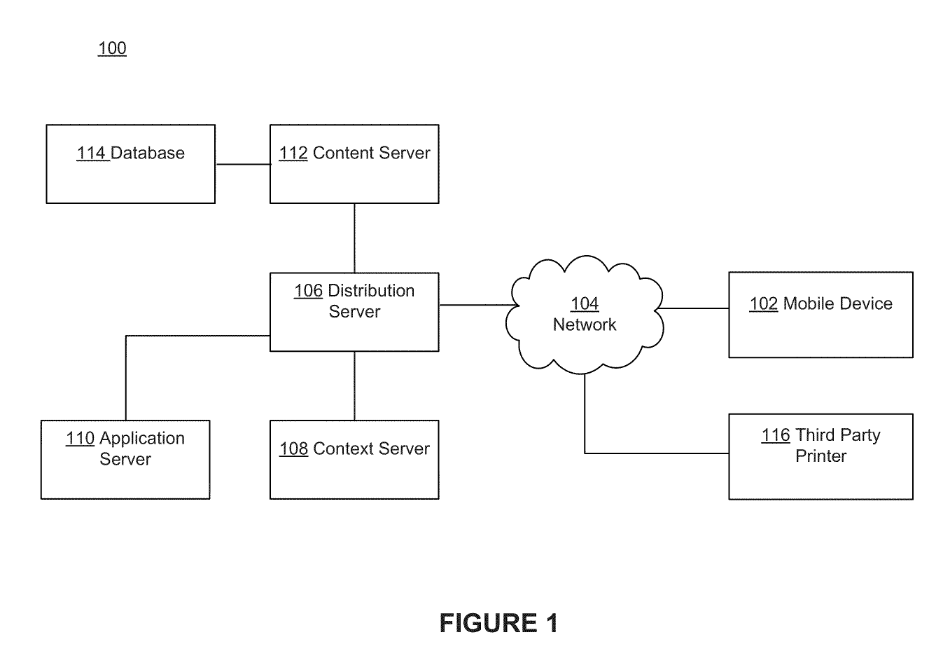

Referring now to the drawings in which like numerals indicate like elements throughout the several Figures, FIG. 1 is a block diagram depicting an exemplary system 100 for implementing sharing photographs with a third party printer. The exemplary system 100 may include a mobile device 102 that is in communication with one or more network servers (e.g., distribution server 106, context server 108, application server 110, content server 112) through a network 104. The network 104 may be an Internet, a Local Area Network (LAN), a Wide Area Network (WAN), a private network, a Wi-Fi, or some other suitable type of network associated topology.

The mobile device 102 is associated with a particular user. The mobile device 102 generally includes functionality that permits the mobile device 102 to capture photographs. For example, the mobile device 102 may have a camera that is capable of taking photographs. Various types of mobile devices 102 may be used. Mobile devices 102 may include, for example, a cell phone, a wireless device, a tablet computer, a personal digital assistant (PDA), a laptop computer, a camera, a UPS enabled device, or any device that may be used for capturing and sharing photographs.

The mobile device 102 may have a display that allows the user to interact with a user interface. The user may use the user interface to interact with a photo sharing application that allows the user to provide the at least one photograph to one or more third party printers 116. The user may use the user interface to define a print region. The user may use the user interface to identify one or more third party printers 116. The one or more third party printers 116 may be within a print region. The user may use the user interface to select one or more third party printers 116. The user may use the user interface to identify at least one photograph to provide to one or more third party printers 116. The user may use the user interface to define certain characteristics associated with the at least one photograph that will be provided to the one or more third party printers 116. The user may use the user interface to provide the at least one photograph to one or more third party printers 116. The user's interactions with the user interface may be communicated to the one or more network servers.

The one or more networks servers (e.g., distribution server 106, context server 108, application server 110, content server 112) may be implemented using hardware, software, firmware, manual processing, or any combination thereof. Sharing photographs with a third party printer may be implemented through one or more software modules executed by the one or more network servers, possibly in cooperation with one or more photo sharing applications executed by a mobile device 102.

The distribution server 106 may be connected to the context server 108, application server 110, and content server 112. These various servers may participate in a cloud computing paradigm. These various servers may be implemented on a single computer system, or multiple computer systems. The distribution server 106 may receive information from the mobile device 102 and route the information to one or more of the servers 108, 110 and 112. In addition, the distribution server 106 may distribute information received from one or more of the servers 108, 110 and 112 to the mobile device 102. In some embodiments, the distribution server 106 may receive information from the one or more mobile devices and route the information to the one or more servers. The distribution server 106 may also distribute information received from the one or more servers to one or more mobile devices.

The context server 108 may be used to determine the current location of the mobile device 102 associated with the user. The context server 108 may use location-based technology, GPS technology, Internet-based technology and the like to determine the location of the user. For example, the context server 108 may monitor or track the coordinates of a mobile device 102 associated with the user. Based on the coordinates, the context server 108 may determine the location of the user. The context server 108 may receive information from the mobile device 102 to determine the current location of the mobile device 102. The context server 108 may send information to the mobile device 102 to determine the current location of the mobile device 102. In some embodiments, the context server 108 may communicate with a location-based component of the mobile device 102 to determine the location of the mobile device 102 associated with the user.

In some embodiments, the context server 108 may determine the location of one or more third party printers 116. The context server 108 may determine the location of the one or more third party printers 116 by using an address or some other identifier associated with one or more third party printers 116. The context server 108 may compare the location of the one or more third party printers 116 to the current location of the mobile device 102 to determine whether the one or more third party printers 116 are within a print region.

The content server 112 may receive at least one photograph and/or other information from the mobile device 102 over the network 104. The content server 112 may receive the at least one photograph from the distribution server 106 which received the at least one photograph from mobile device 102. The content server 112 may provide the at least one photograph and/or other information to one or more third party printers 116. For example, the content server 112 may provide photographs captured by the mobile device 102 to one or more third party printers 116. At least one photograph may also be electronically stored on the mobile device 102. In some embodiments, the distribution server 108 may receive at least one photograph from the content server 112 and provide the at least one photograph to one or more third party printers 116. The at least one photograph may be shared with one or more third party printers 116 in a variety of ways.

The at least one photograph may be stored on the content server 112. The least one photograph may be stored in the local memory of the content server 112, which may include a RAM, hard disk, removable disks, tape arrays, or any other computer-readable medium. Alternatively, or additionally, the content server 112 may have a database 114 for storing at least one photograph and/or other data. The content server 112 may store at least one photograph captured by the user.

In some embodiments, at least one photograph may be electronically stored on the mobile device 102. The user of the mobile device 102 may provide the at least one photograph directly to the one or more third party printers 116 over the network 104. In this embodiment, the user of the mobile device 102 may provide the at least one photograph to the one or more third party printers 116 over the network 104 without any interaction with one or more servers.

The application server 110 may access the coordinates of a print region. The print region may be stored within a local memory of the application server 110. The application server 110 may communicate with the mobile device 102 associated with the user to obtain the print region. For example, the application server 110 may receive a user defined region or geographical area from the mobile device 102 user when the user interacts with the photo sharing application. In some embodiments, the application server 110 may communicate with a party other than the mobile device user to obtain the print region. In another embodiment, the print region may be stored on one or more of the servers. The application server 110 may communicate with the one or more servers to obtain the print region. In another embodiment, the print region may be stored on the mobile device 102. For example, the user may interact with the photo sharing application to input the print region and the print region may be stored on the mobile device 102. The mobile device 102 may provide the print region to the one or more servers.

The application server 110 may identify one or more third party printers 116 that are within the print region. The application server 110 may communicate with the context server 108 or one or more servers to obtain the location of one or more third party printers 116. The application server 110 may use the internet to determine the location of the one or more third party printers 116. The application server 110 may communicate with the mobile device 102 to determine the location of the one or more third party printers 116. The application server 110 may compare the coordinates of one or more third party printers 116 and the print region to determine whether the one or more printers 116 are within the print region. The application server 110 may provide an indication to the user that one or more third party printers 116 are within the print region. The indication may be an identifier on a map of a graphical user interface of the photo sharing application. The application server 110 may also receive information related to the one or more third party printers 116 selected by the user. In some embodiments, the application server 110 may communicate with the one or more third party printers 116 to provide at least one photograph.

The one or more servers 106, 108, 110 and 112 and/or the mobile device 102 may comprise a computer-readable medium such as a random access memory (RAM) coupled to a processor that executes computer-executable program instructions and/or accesses information stored in memory. Such a processor may comprise a microprocessor, an ASIC, a state machine, or other processor, and can be any of a number of computer processors. Such a processor can comprise, or may be in communication with a computer-readable medium which stores instructions that, when executed by the processor, cause the processor to perform the steps described herein.

A computer-readable medium may comprise, but is not limited to, an electronic, optical, magnetic, or other storage device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. The instructions may comprise processor-specific instructions generated by a compiler and/or an interpreter from code written in any suitable computer-programming language, including, for example, C, C++, C#, Visual Basic, Java, Python, Perl, JavaScript, and ActionScript.

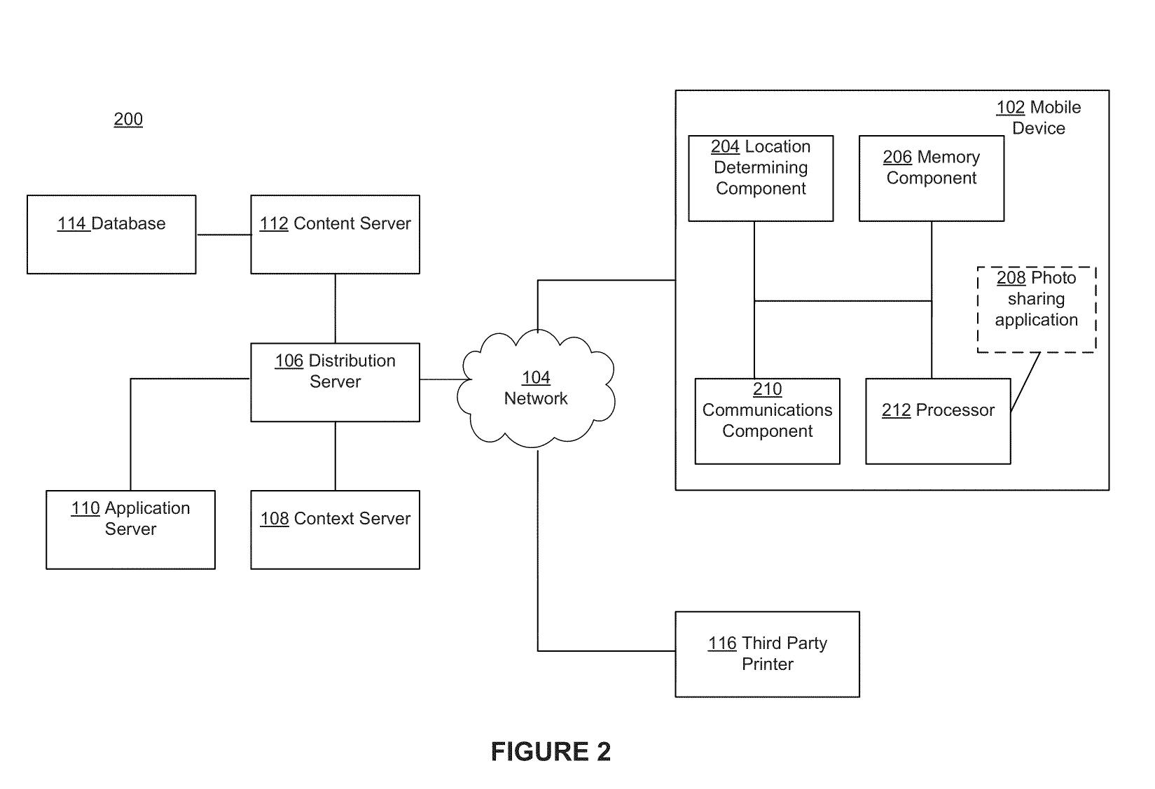

FIG. 2 is a block diagram depicting an exemplary system 200 for implementing sharing photographs with a third party printer. The exemplary system 200 illustrates details of the mobile device 102. The mobile device 102 may include a location determining component 204, a memory component 206, a communications component 210, and a processor 212.

The processor 212 may communicate with the location determining component 204, memory component 206, and communications component 210. The processor 212 may process data and execute any of a software module or an executable software program, and cause data to be stored. The operation of the processor 212 may include executing software or coded instructions that may in particular embodiments be associated with the one or more function modules.

The processor 212 may run an executable application. The executable application may be the photo sharing application 208. The photo sharing application 208 may be used to provide at least one photograph to one or more third party printers 116. The one or more third party printers 116 may be within a print region. The photo sharing application 208 may be used to capture photographs. The photo sharing application 208 may be used to define a print region. The photo sharing application 208 may be used to identify one or more third party printers 116 that are within the print region. The photo sharing application 208 may be used to select at least one photograph to provide to the one or more third party printers 116. The photo sharing application 208 may be used to select one or more third party printers 116. The one or more third party printers 116 may receive the at least one selected photograph. The photo sharing application 208 may be used to provide at least one photograph to the one or more third party printers 116.

The photo sharing application 208 may function as a user interface. The photo sharing application 208 may receive commands from the mobile device 102 of the user to activate certain features or components of the mobile device 102. The photo sharing application 208 may initiate and/or communicate a command from the mobile device user to operate the appropriate component. The photo sharing application 208 may perform sonic, none, or all of the functions of the mobile device 102.

The memory 206 may be coupled to the processor 212 and may include one or more suitable memory devices, such as one or more random access memories (RAMs), read-only memories (ROMs), dynamic random access memories (DRAMs), fast cycle RAMs (FCRAMs), static RAM (SRAMs), field-programmable gate arrays (FPGAs), erasable programmable read-only memories (EPROMs), electrically erasable programmable read-only memories (EEPROMs), microcontrollers, or microprocessors. In some embodiments, at least one photograph may be stored on the memory 206.

The location determining component 204 may be used to determine the location of the mobile device 102 associated with the user. The location determining component 204 may enable and/or include location based functionality (e.g. GPS technology, Internet technology) of the mobile device 102. The location determining component 204 may communicate with the one or more servers to help determine the current location of the mobile device 102. The location determining component 204 may communicate with the communications component 210, memory component 206, and processor 212 to assist in determining the current location of the mobile device 102. In some embodiments, the location determining component 204 may communicate with a satellite to determine the current geographic location of the mobile device 102.

The communications component 210 may be connected to the location determining component 204, memory component 206, and processor 212. The communications component 210 may receive information from the location determining component 204, memory component 206, and processor 212 and route the information to one or more of the servers 106, 108, 110 and 112. In addition, the communications component 210 may receive information from the one or more servers 106, 108, 110 and 112 and route the information to the location determining component 204, memory component 206, and processor 212. The communications component 210 may receive information from the location determining component 204, memory component 206, and processor 212 and route the information to one or more third party printers 116.

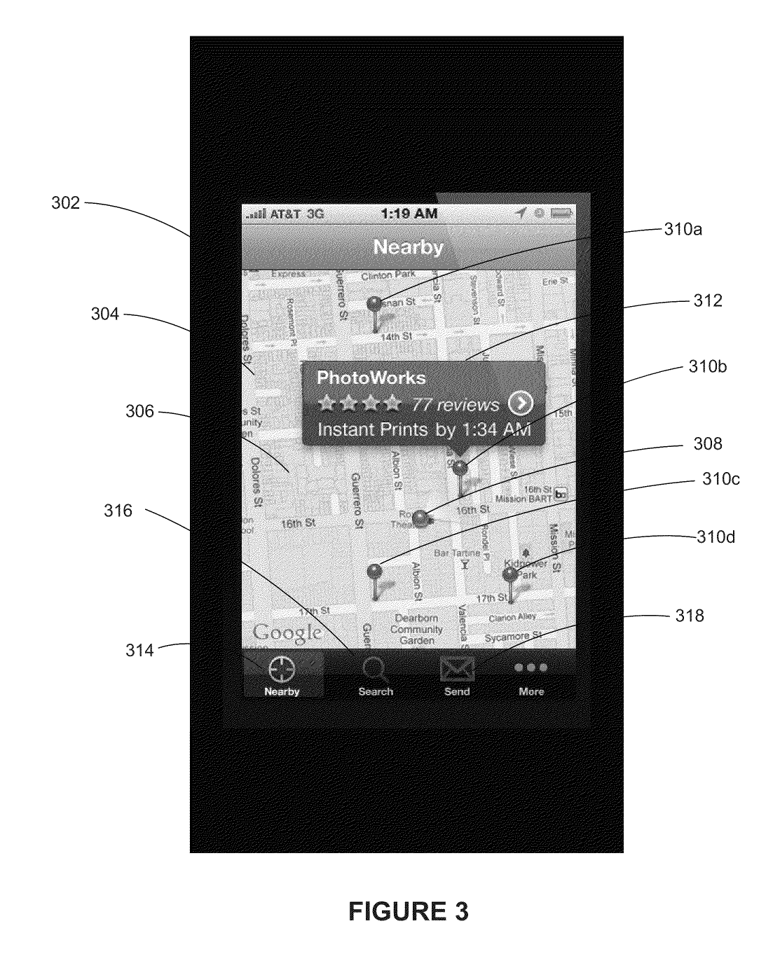

FIG. 3 is an illustration depicting an exemplary user interface for a photo sharing application. As illustrated in FIG. 3, the user interface 304 may be a user interface of the photo sharing application. The user interface 304 may be shown on a display of a mobile device 302 associated with a user. The user interface 304 may also include a map 306 that indicates the current location of the user 308. The map 306 may indicate one or more third party printers 310a-d. The one or more third party printers 310a-d may be within a print region.

The user interface 304 may include functionality to view on a map 306 one or more third party printers 310a-d that are near the current location of the user 308. The user interface 304 may include a Nearby function 314 that permits the user to view on a map 306 one or more third party printers 310a-d that are near the current location of the user 308. The user interface 304 may include functionality to search for one or more third party printers. The user interface 304 may include a Search function 316 that permits the user to search for one or more third party printers. The user may use the Search function 316 to locate one or more third party printers by searching the name, address and the like of one or more third party printers.

In some embodiments, the photo sharing application may provide detailed information about one or more third party printers 310a-d. For example, FIG. 3 illustrates detailed printer information 312 associated with a particular third party printer 310b. The detailed printer information 312 provides the name of the third party printer, reviews of the third party printer, and a time by which the third party printer can print the at least one photograph. The detailed printer information 312 can include any other type of information associated with the third party printer 310b and other information that would help the user of the mobile device when selecting a third party printer. The detailed information about the one or more third party printers 310a-d may be shown when the user interacts with the user interface 304.

The user interface 304 may include functionality to select at least one photograph. The at least one photograph may be stored electronically on a server of a cloud computing network and/or on the mobile device 302. The user may use the user interface 304 to identify at least one photograph to send to one or more third party printers 310a-d.

The user interface 304 may include functionality to select one or more third party printers 310a-d. The user interface 304 may include a Select function that permits the user to select one or more third party printers 310a-d, In some embodiments, the Select function may include the user interacting with the user interface 304 by pressing on an identifier associated with one or more third party printer 310a-d, For example, the user may press on a pin on the graphical user interface that is associated with a third party printer in which the user intends to select.

The user interface 304 may include functionality to send at least one photograph to one or more third party printers 310a-d, The user interface 304 may include a Send function 318 that permits the user to send at least one photograph to one or more third party printers 310a-d.

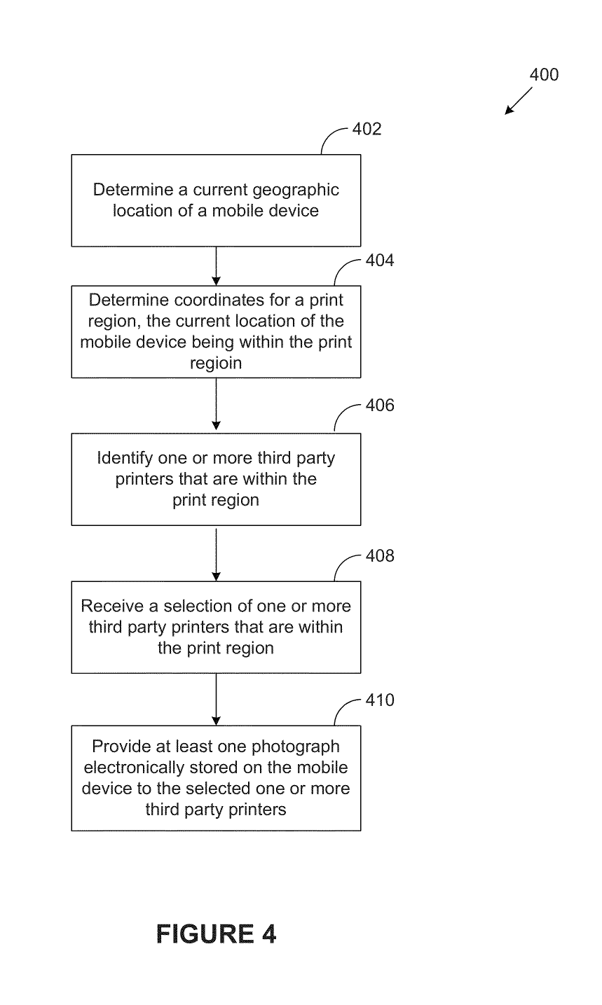

FIG. 4 is a flow chart illustrating an exemplary method of sharing photographs with a third party printer. At block 402, a current location of a mobile device 102 is determined. As described above, the current location of the mobile device may be determined using GPS technology or Internet technology. The current location of the mobile device may also be determined by tracking a wireless access point, a cell phone tower, or any other mobile device tracking technology.

At block 404, coordinates for a print region are determined. The coordinates of the print region may be determined by accessing stored coordinates of the print region. The coordinates of the print region may be determined by the user inputting print region coordinates. The coordinates of the print region may be stored on the mobile device 102. In some embodiments, the coordinates of the print region may be stored on one or more servers. The mobile device 102 associated with the user is within the print region. The coordinates for a print region may be determined by the user interacting with a photo sharing application on the mobile device 102.

At block 406, one or more third party printers within the print region are identified. The location of the one or more third party printers 116 may be compared to the print region to determine whether the one or more third party printers 116 are within the print region. In some embodiments, the mobile device 102 may receive an indication that one or more third party printers 116 are within the print region. The one or more third party printers 116 may be identified on a photo sharing application on the mobile device 102. The one or more third party printers 116 may be illustrated on a map of the photo sharing application.

At block 408, one or more third party printers that are within the print region are selected. The mobile device 102 may receive a selection of the one or more third party printers 116. The user may use the mobile device 102 to select the one or more third party printers 116. The user may interact with a photo sharing application to select the one or more third party printers 116. In some embodiments, the user may select an identifier associated with one or more third party printers 116 to select the one or more third party printers 16. In some embodiments, the user may select one or more third party printers 116 by pressing on an identifier associated with one or more third party printers 116 on the photo sharing application.

At block 410, at least one photograph is provided to one or more selected third party printers. The at least one photograph provided is electronically stored on the mobile device. The at least one photograph provided may be electronically stored on a server of a cloud computing network. The user may select at least one photograph to provide to one or more third party printers 116. The user may use the photo sharing application to select at least one photograph to provide to one or more third party printers 116. The one or more third party printers 116 may receive at least one photograph from the mobile device and print the at least one photograph. The one or more third party printers 116 may print the photograph in accordance with instructions from the user.

### General

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. A method comprising:
determining a current geographic location of a mobile device;
determining coordinates for a print region, the current geographic location of the mobile device being within the print region;
identifying one or more third party printers that are within the print region;
receiving a selection of the one or more third party printers that are within the print region; and
providing at least one photograph electronically stored on the mobile device to the selected one or more third party printers, wherein the selected one or more third party printers are configured to print the at least one photograph.

2. The method of claim 1, further comprising:
identifying at least one individual that is configured to receive the at least one photograph configured to be printed by the third party printer.

3. The method of claim 1, further comprising:
selecting the at least one photograph using the mobile device.

4. The method of claim 1, wherein the third party printer is a printer on demand kiosk.

5. The method of claim 1, further comprising:
printing the at least one photograph by the third party printer.

6. The method of claim 5, wherein the photograph is printed on a print, letter, press card, poster, or used to create a photo book.

7. The method of claim 1, further comprising:
capturing the at least one photograph using the mobile device.

8. The method of claim 1, wherein the current location of the mobile device is determined by monitoring the mobile device using a global position system.

9. The method of claim 1, wherein the print region is defined based on input at the mobile device.

10. A non-transitory computer-readable medium on which is encoded program code, the program code comprising:
program code for determining a current geographic location of a mobile device;
program code for determining coordinates for a print region, the current geographic location of the mobile device being within the print region;
program code for identifying one or more third party printers that are within the print region;
program code for receiving a selection of the one or more third party printers that are within the print region; and
program code for providing at least one photograph electronically stored on the mobile device to the selected one or more third party printers, wherein the selected one or more third party printers are configured to print the at least one photograph.

11. The computer-readable medium of claim 10, further comprising:
program code for identifying at least one individual that is configured to receive the at least one photograph configured to be printed by the third party printer.

12. The computer-readable medium of claim 10, further comprising:
program code for printing the at least one photograph by the third party printer.

13. The computer-readable medium of claim 12, wherein the photograph is printed on a print, letter, press card, poster, or used to create a photo book.

14. The computer-readable medium of claim 10, further comprising:
program code for capturing the at least one photograph using the mobile device.

15. The computer-readable medium of claim 10, wherein the current location of the mobile device is determined by monitoring the mobile device using a global positioning system.

16. A system comprising:
a computer-readable medium; and
a processor in communication with the computer-readable medium, the processor configured to:
determine a current geographic location of a mobile device;
determine coordinates for a print region, the current geographic location of the mobile device being within the print region;
identify one or more third party printers that are within the print region;
receive a selection of the one or more third party printers that are within the print region; and
provide at least one photograph electronically stored on the mobile device to the selected one or more third party printers, wherein the selected one or more third party printers are configured to print the at least one photograph.

17. The system of claim 16, wherein the processor is further configured to identify at least one individual that is configured to receive the at least one photograph configured to be printed by the third party printer.

18. The system of claim 16, wherein the processor is further configured to print the at least one photograph by the third party printer.

19. The system of claim 18, wherein the photograph is printed on a print, letter, press card, poster, or used to create a photo book.

20. The system of claim 16, wherein the processor is further configured to capture the at least one photograph using the mobile device.

21. The system of claim 16, wherein the processor is further configured to determine the current location of the mobile device by monitoring the mobile device using a global positioning system.
